(19) United States
(12) Patent Application Publication
(10) Pub. No.: US 2005/0267223 A1
(43) Pub. Date: Dec. 1, 2005

(54) Impregnating agent

(76) Inventors: Volker Schlicht, Velbert (DE); Petra Koelsch, Berlin (DE)

Correspondence Address: MARSHALL & MELHORN, FOUR SEAGATE, EIGHT FLOOR, TOLEDO, OH, 43604, US

(21) Appl. No.: 11/127,479

(22) Filed: May 12, 2005

Related U.S. Application Data
(63) Continuation-in-part of application No. 10/466,783, filed on Feb. 11, 2004, now abandoned.

(30) Foreign Application Priority Data
Jan. 19, 2001 (DE) 101 04 394.5

(51) Int. Cl. B01F 3/08

(52) U.S. Cl. 516/21; 516/23; 516/27

(57) ABSTRACT

A novel impregnating agent for leather, textiles and synthetic materials, contains at least one impregnating active ingredient incorporated into a dispersing system. At least one impregnating active ingredient is contained in the dispersing agent of a water-in-oil emulsion which forms the impregnating agent. Said impregnating agent can be produced with a desired viscosity without the need for a thickening agent to be used. Preferably, an oil-soluble emulsifier is used, containing additional impregnating qualities.

### CROSS REFERENCE TO RELATED APPLICATIONS

This application is a continuation-in-part application of U.S. patent application Ser. No. 10/466,783, which was a U.S. National phase application of International application PCT/EP02/00561, which entered the national phase in the United States on Jul. 18, 2003. U.S. application Ser. No. 10/466,783 was pending as of the filing date of this application. U.S. application Ser. No. 10/466,783 is hereby incorporated by reference as if set forth in its entirety herein.

### BACKGROUND OF THE INVENTION

The invention relates to an impregnating agent for leather, textiles and synthetic materials, containing at least one impregnating active ingredient which is incorporated in a dispersed system.

Impregnating agents contain the impregnating active ingredients normally in a dissolved form or in a form emulsified/dispersed in water (oil-in-water emulsion). Mainly organic liquids, such as heptane isomers, benzenes or isopropanol, serve as solvent.

Impregnating agents of this type containing solvents can however be risky because of their health-endangering effects, in particular when they are sprayed onto a surface to be treated (toxicological inhalation risk due to spray mists). They should therefore not be applied in closed rooms.

When impregnating agents of this type are applied mechanically, for example by means of a sponge onto smooth leather surfaces, the solvent can cause damage to the finish which leads to a blotchy and hence unsightly appearance.

A liquid impregnating and care product for leather, artificial leather materials and textiles with an impregnating active ingredient on fluorocarbon resins, fluorosilicones and/or organic metal compounds is known from EP 0 527 496 Al, which contains a volatile silicone as solvent or dispersing agent. Damage to the finish should not occur in the case of the latter. It is however disadvantageous here that the evaporation of the silicone can take a fairly long time and that the production of the agent is relatively costly.

The disadvantage of a water-based emulsion (oil-in-water emulsion) is the necessary use of water-soluble emulsifiers. Since these substances remain on the treated surface, they counteract the desired impregnation due to their hydrophilicity. In addition, thickening agents are required for this emulsion if it is intended to have a cream- or gel-like consistency. These thickening agents also form residues on the treated surface, as a result of which these become unsightly and, particularly when treating suede leather, conglutination of the fibres can occur, which leads to additional staining.

It is therefore an object of the present invention to indicate an impregnating agent for leather, textiles and synthetic materials, containing at least one impregnating active ingredient which is incorporated in a dispersed system which can be applied mechanically and thereby is distributed uniformly, leaves no residues on the treated surface apart from the desired active ingredients and is at least extensively solvent-free.

### SUMMARY OF THE INVENTION

This object is achieved according to the invention by an impregnating agent wherein at least one impregnating active ingredient is contained in the dispersing agent of a water-in-oil emulsion which forms the impregnating agent, having a water proportion of 30-95 percent by weight, and wherein the impregnating agent does not include a pthalic anhydride derivative, and the oil phase does not include a chlorinated alkane solvent. Advantageous developments of the impregnating agent according to the invention are further revealed herein.

### DESCRIPTION OF THE PREFERRED EMBODIMENTS

As a result of the fact that at least one impregnating active ingredient is contained in the dispersing agent of the water-in-oil emulsion which forms the impregnating agent, i.e. that water represents the internal phase of the emulsion, the viscosity of the emulsion can be determined solely by the size of the water proportion; the greater the water proportion is, the more viscose is the emulsion. This can hence obtain a cream- or gel-like consistency without using any thickening agents. It is noteworthy that the water proportion of the emulsion can be up to 95% by weight, whilst normally the proportion of the external phase in an emulsion is greater than the proportion of the internal phase.

Preferably, the impregnating agent contains an oil-soluble emulsifier which itself already has hydrophobing properties and hence increases the impregnating effect. Silicone emulsifiers, of which in particular polyether polydimethyl siloxane copolymers should be mentioned, have proved to be particularly suitable.

Suitable impregnating active ingredients are fluorocarbon polymers (fluorocarbon resins) which have such a high surface tension that they have not only water-repellant properties but also oil-repellant properties. A further advantageous impregnating active ingredient is aminofunctional siloxane which likewise is highly water-repellant and in addition improves the polishing ability on smooth leather (polydimethyl siloxanes have proved here to be particularly expedient). Aminofunctional siloxanes of this type are reactive substances which can have a health-damaging effect. They are therefore unsuitable for a spray application but can be used safely for application with a sponge, a cloth or a brush.

In addition, fats and/or oils can increase the suppleness and softness of the treated surface and hence improve the surface texture.

A general formulation for an embodiment of an impregnating agent according to the present invention can have the following composition (values in % by weight):

| | | | |
|---|---|---|---|
| wool grease(lanolin) | 0.01-5% | preferably | 0.1-3% |
| n-iso/cyclic aliphates | 0.5-20% | preferably | 2-6% |
| (white spirit) | | | |
| silicone emulsifier | 0.5-10% | preferably | 0.5-4% |
| paraffin oil | 0.1-10% | preferably | 0.1-3% |
| polydimethyl siloxanes | 0.1-10% | preferably | 0.5-4% |
| (aminofunctional) | | | |
| plant oils | 0.1-5% | preferably | 0.1-2% |
| fluoroalkyl copolymers | 0.1-10% | preferably | 1-5% |
| scents, colourants | 0-2% | preferably | 0.1-0.5% |
| water (demineralised) | 30-95% | preferably | 70-95% |

The aminofunctional polydimethyl siloxanes and the fluoroalkyl copolymers here are primarily impregnating active ingredients and the wool grease, the paraffin oil and also the plant oils serve primarily as care products. The silicone emulsifier gives the emulsion the required stability and has in addition the property of an impregnating active ingredient. The white spirit is used as solvent for the oil-soluble components.

The production of this impregnating agent can be effected in such a manner that firstly the wool grease is dissolved in the white spirit at a temperature of approximately 50° C. Subsequently, the oil-soluble components (all components apart from the water) are added and agitated homogeneously. Finally the mixture is mixed slowly with water with intensive agitation, a water-in-oil emulsion being formed. The addition of water is effected until the desired viscosity is achieved (an increase in the water proportion increases the viscosity).

The thus obtained impregnating agent is applied according to specification with a sponge or cloth onto the surface to be treated. After sufficient drying time, smooth leathers are polished, suede leathers are roughened and textiles are brushed. The application can be repeated many times without a negative change in the appearance of the material surface occurring. Rather, smooth and suede leathers become more intensively coloured.

In an embodiment of the present invention, an impregnating agent for leather, textiles and synthetic materials contains at least one impregnating active ingredient which is incorporated in a dispersed system. At least one impregnating active ingredient is contained in the dispersing agent of a water-in-oil emulsion which forms the impregnating agent, having a water proportion of 30-95 percent by weight. In at least one embodiment, the impregnating agent does not include a pthalic anhydride derivative, and the oil phase does not include a chlorinated alkane solvent. In other words, in at least one embodiment of the present invention, pthalic anhydride derivatives are excluded from the impregnating agent, and chlorinated alkane solvents are excluded from the oil phase.

The impregnating tests which were implemented produced the following results:

1. Water drop test (after 3 m): observation time 10 s; the drawing-in of the drop into the material was assessed

| Type of material | Untreated | Treated with impregnating gel |
|---|---|---|
| Smooth leather (coated) | 10 | 10 |
| Nubuck leather | 1 | 10 |
| Suede leather | 1 | 10 |
| Calf leather | 7 | 10 |
| Textile (cotton) | <W | 8 |

2. Oil-repellent test according to MTCC 118

| Type of material | Untreated | Treated with impregnating gel |
|---|---|---|
| Smooth leather(coated) | 6 | 8 |
| Nubuck leather | 2 | 4 |
| Suede leather | 2 | 3 |
| Calf leather | 3 | 5 |
| Textile (cotton) | <1 | 4 |

1. An impregnating agent for leather, textiles and synthetic materials, containing at least one impregnating active ingredient which is incorporated in a dispersed system, wherein at least one impregnating active ingredient is contained in the dispersing agent of a water-in-oil emulsion which forms the impregnating agent, having a water proportion of 70-95 percent by weight, and wherein the impregnating agent does not include a pthalic anhydride derivative, and the oil phase does not include a chlorinated alkane solvent.

2. The impregnating agent according to claim 1, comprising impregnating active ingredients which are selected from the group consisting of: aminofunctional siloxanes and fluorocarbon polymers.

3. The impregnating agent according to claim 2, wherein the impregnating active ingredients comprise an aminofunctional siloxane which is a polydimethyl siloxane.

4. The impregnating agent according to claim 2, wherein the impregnating active ingredients comprise a fluorocarbon polymer which is a fluoroalkyl copolymer.

5. The impregnating agent according to claim 1, comprising an oil-soluble emulsifier.

6. The impregnating agent according to claim 5, wherein the emulsifier is a silicone emulsifier.

7. The impregnating agent according to claim 6, wherein the silicone emulsifier is a polyether-polydimethyl siloxane copolymer.

8. The impregnating agent according to claim 1, comprising in addition care active ingredients.

9. The impregnating agent according to claim 8, wherein the care active ingredients comprise wool grease and/or paraffin oil and/or plant oils.

10. The impregnating agent according to claim 1, comprising oil-soluble scents and/or colorants.

11. The impregnating agent according to claim 1, comprising n-iso/cyclic aliphates as solvent for oil-soluble components.

12. The impregnating agent according to claim 3, wherein the polydimethyl siloxane has a proportion of 0.1-10 percent by weight.

13. The impregnating agent according to claim 12, wherein the polydimethyl siloxane has a proportion of 0.5-4 percent by weight.

14. The impregnating agent according to claim 4, wherein the fluorocarbon polymers have a proportion of 0.1-10 percent by weight.

15. The impregnating agent according to claim 14, wherein the proportion of fluorocarbon polymers is 1-5 percent by weight.

16. The impregnating agent according to claim 6, wherein the silicone emulsifier has a proportion of 0.5-10 percent by weight.

17. The impregnating agent according to claim 16, wherein the proportion of silicone emulsifier is 0.5-4 percent by weight.

18. The impregnating agent according to claim 9, comprising wool grease with a proportion of 0.01-5 percent by weight.

19. The impregnating agent according to claim 9, comprising paraffin oil with a proportion of 0.1-10 percent by weight.

20. The impregnating agent according to claim 9, comprising plant oils with a proportion of 0.1-5 percent by weight.

21. The impregnating agent according to claim 10, wherein the scents and/or colorants have a proportion of 0-2 percent by weight.

22. The impregnating agent according to claim 11, wherein the n-iso/cyclic aliphates have a proportion of 0.5-20 percent by weight.
